(19) United States
(12) Patent Application Publication
(10) Pub. No.: US 2010/0013712 A1
(43) Pub. Date: Jan. 21, 2010

(54) MOBILE STATION POSITION LOCATING METHOD

(75) Inventor: Yoshiki Yano, Aichi-gun (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/567,216

(22) Filed: Sep. 25, 2009

Related U.S. Application Data
(63) Continuation-in-part of application No. PCT/JP2008/055983, filed on Mar. 27, 2008.

(30) Foreign Application Priority Data
Mar. 28, 2007 (JP) 2007-085169

(51) Int. Cl. G01S 5/14

(52) U.S. Cl. 342/463

(57) ABSTRACT

A mobile station position locating method is provided for accurately locating positions of base stations without actually locating the positions of the base stations for locating the mobile station. In a transmit and receiving time detecting step (S6, S7), transmitting times ts1 to ts4 of radio waves transmitted from plural stationary transmitters C1 to C4 set up in known positions, and receiving times s1 to s4, i.e., propagation times of the radio waves are detected. In a base-station position calculating step (S4), positions (Xn, Yn, Zn; n=1 to 4) of the base stations K1 to K4 are calculated based on propagation distances l1, l2, l3 and l4 between the plural stationary transmitters C1 to C4, and a predetermined base station K1 calculated based on the transmitting times ts1 to ts4 of the receiving times s1 to s4 of the radio waves, and the known positions (xn, yn, zn; n=1˜4) of the stationary transmitters C1 to C4. This enables the positions of the base stations K1 to K4 to be accurately located without actually measuring the positions of thereof.

### BACKGROUND OF THE INVENTION

1. Field of the Invention

This invention relates to a mobile station position locating method in which plural base stations receives radio wave from a mobile station to locate a position of the mobile station respectively, based on each of propagation times of the radio waves received at the plural base stations and positions of the plural base stations. In particular, it relates to a technique to accurately locate the position of the mobile station.

2. Description of the Related Art

Attempts have heretofore been made to detect or locate positions of a movable article and living object. To this end, mobile stations such as RFID tag or small-sized transmitter operative to transmit radio waves are attached to the article and the living object, respectively. To locate position of a mobile station, a position locating method as below has been known. The mobile station sends radio wave, which is received at plural base stations that are preliminarily set up. The position of the mobile station is located based on propagation times of the radio waves received at the plural base stations, and positions of the plural base stations. Patent Publication 1 discloses such a mobile station position locating method.

Further, another mobile station position locating method has been known in which a mobile station sends radio wave to plural stationary tags that are preliminarily set up. The plural stationary tags provide reflection waves that are received again at the mobile station to locate the position of the mobile station, based on radio field intensities of such reflection waves and positions of the plural stationary tags. Patent Publication 2 discloses such a mobile station position locating method.

[Patent Publication 1] Japanese Patent Publication No. 2005-110314

[Patent Publication 2] Japanese Patent Publication No. 2006-118998

### DISCLOSURE OF THE INVENTION

### Subject to be Solved by the Invention

In the conventional position locating method, the position of the mobile station or a tag leader is located on a premise that the positions of the base stations or the positions of the stationary tags are known. Thus, no problem arises when the base stations are disposed at positions that can be easily located with increased precision. In general, however, in most cases the base stations are set up at high places with a good view for increasing receiving sensitivity thereof. Thus, it takes much time in actually measuring the positions of the base stations, and it is unable to obtain high locating precision or accuracy, which cause an error occurring in a detected position of the mobile station.

The present invention has been completed with the above situations in mind, and has an object to provide a mobile station position locating method which can accurately locate positions of base stations, without actually locating the positions of the base stations for locating a position of a mobile station.

For achieving the above object, the invention recited in claim 1 is related to a mobile station position locating method for locating a position of the mobile station based on propagation times of the radio waves, transmitted and received between a mobile station and plural base stations, and positions of the plural base stations. The mobile station position locating method comprises base-station position calculating step that calculates the positions of the plural base stations, based on the propagation times of the radio waves transmitted from plural stationary transmitters set up at plural known positions in a position locating space for the mobile station respectively to the plural base stations, and the known positions of the plural stationary transmitters.

### EFFECT OF THE INVENTION

According to the invention recited in claim 1, the positions of the plural base stations are calculated based on the propagation times of the radio waves transmitted from the plural stationary transmitters located at the known plural positions respectively to each of the plural base stations, and the known positions of the plural stationary transmitters. Thus, the positions of the plural base stations can be accurately located without actually measuring the positions thereof. In addition, position of the mobile station can be located based on the propagation distance of the radio waves received by plural base stations from the mobile station, and the position of the base stations.

Preferably, the mobile station position locating method further comprises stationary-transmitter setting-up step that sets up the plural stationary transmitters at a place, i.e., a site or an area already positionally determined on electronic data such as a CAD drawing data. According to the stationary-transmitter setting-up step, the positions of the stationary transmitters are accurately and easily calculated, and are input to an electronic control device for locating the mobile station.

Preferably, the stationary-transmitter setting-up step sets up the plural stationary transmitters at four places or more in the position locating space. According to such operation, with setting up the plural stationary transmitters for the mobile station at the four places or more in the position locating space, the position of the mobile station can be obtained as a three-dimensional coordinate.

Preferably, the stationary-transmitter setting-up step sets up the plural stationary transmitters at corner portions thereof or at fixed positions spaced from the corner portions in the position locating space. According to such operation, the plural stationary transmitters can be set up in the position locating space at the corner portions thereof or at the positions positionally related to the corner portions, so that the positions of the stationary transmitters can be accurately obtained with increased precision.

Preferably, the mobile station position locating further comprises stationary-transmitter clock tuning step that calculates clock gaps between the plural stationary transmitters based on (i) the propagation times of the radio waves calculated based on distances between the plural stationary transmitters depending on the known positions of the plural stationary transmitters, and speeds of the radio waves, and (ii) actually measured propagation time of the radio waves representing time periods between a transmitting time of a radio wave transmitted from one of the plural stationary transmitters and a receiving time of the radio waves received at the other stationary transmitters. The base-station position calculating step calculates propagation distances based on the propagation times of the radio waves transmitted from the plural stationary transmitters to the plural base stations with considering the clock gaps between the stationary transmitters, and then calculates the positions of the plural base stations based on the propagation distances and the known positions of the stationary transmitters.

According to the stationary-transmitter clock tuning step, with considering mutual clock gap between the stationary transmitters, i.e., clock distances of clock gaps, the positions of the plural stationary transmitters can be calculated in terms of distances, based on the propagation times of the radio waves transmitted from the plural stationary transmitters to the plural base stations. Therefore, the position of the mobile station can be accurately located based on the propagation distances of the radio waves transmitted from the mobile station and received at the plural base stations, respectively, and the positions of the plural base stations.

Preferably, the mobile station position locating method further comprises (a) base-station clock tuning step that calculates mutual clock gaps between the base stations based on (i) the propagation times of the radio waves calculated based on distances between the plural base stations obtained by the base-station position calculating step, and speeds of the radio waves, and (ii) actually measured propagation times of the radio waves representing time periods between a transmitting time of the radio wave transmitted from one of the plural base stations and a receiving time of the radio wave received at the other base stations; and (b) mobile-station position calculating step that calculates the position of the mobile station based on the propagation distances calculated based on the propagation time of the radio wave transmitted from the mobile station to the plural base stations with considering the mutual clock gaps between the base stations, and positions of the base stations calculated by the base-station position calculating step. According to the base-station clock tuning step and the mobile-station position calculating step, the position of the mobile station can be accurately located based on the clock gaps between the base stations, and the propagation times of the radio waves from the mobile station to the plural base stations.

Preferably, a position locating server connected to the plural base stations is provided to execute the stationary-transmitter clock tuning step, the base-station position calculating step, the base-station clock tuning step and the mobile-station position calculating step.

### BRIEF DESCRIPTION OF THE DRAWINGS

FIG. 1 is a perspective view illustrating a position locating space P in which stationary transmitters and base stations are disposed in a communication system to which the present invention is applied.

FIG. 2 is a view showing a connecting relationship between the base stations and a position locating server in the communication system of an embodiment shown in FIG. 1.

FIG. 3 is a block diagram illustrating a structure of a mobile station M movable within the position locating space P shown in FIGS. 1 and 2.

FIG. 4 is a block diagram illustrating a structure of each stationary transmitter set up in the position locating space P shown in FIGS. 1 and 2.

FIG. 5 is a block diagram illustrating a structure of the base station set up in the position locating space P shown in FIGS. 1 and 2.

FIG. 6 is a block diagram illustrating a structure of the position locating server shown in FIG. 2.

FIG. 7 is a view illustrating an arrangement example of the stationary transmitter as structured shown in FIG. 4 in the position locating space P.

FIG. 8 is a flow chart illustrating a major part of operations of the mobile station with as structured shown in FIG. 3.

FIG. 9 is a flow chart illustrating a major part of operations of the stationary transmitter as structured shown in FIG. 4.

FIG. 10 is a flow chart illustrating a major part of operations of the base station with as structured shown in FIG. 5.

FIG. 11 is a flow chart illustrating a major part of operations of the position locating server as structured shown in FIG. 6.

FIG. 12 is a flow chart illustrating operations of a clock gap calculate routine between the stationary transmitters executed at S3 in FIG. 11.

FIG. 13 is a flow chart illustrating operations of the position calculate routine of the base station executed at S4 in FIG. 11.

FIG. 14 is a flow chart illustrating operations of a clock gap calculate routine between the base stations executed at S5 in FIG. 11.

FIG. 15 is a view illustrating a state in which a predetermined stationary transmitter transmits a synchronizing code to the other stationary transmitters in response to a transmit command, in the operation to execute the clock gap calculate routine between the stationary transmitters shown in FIG. 12.

FIG. 16 is a view illustrating a state in which respective stationary transmitter transmit a transmitting time and a receiving time to a predetermined base station, in the operation to execute the cock error calculate routine between the stationary transmitters shown in FIG. 12.

FIG. 17 is a view illustrating a state in which the respective stationary transmitter transmit a transmitting time serving as a base for calculating distances between the predetermined base station and the respective stationary transmitters, in the operation to execute the base station position calculate routine between the based stations shown in FIG. 13.

FIG. 18 is a view illustrating a state in which the predetermined base station in response to a transmit command transmits synchronizing codes to the other base stations, while the respective base stations transmit a transmitting time and a receiving time to the position locating server, in the operation to execute the clock gap calculate routine between the stationary transmitters shown in FIG. 14.

FIG. 19 is a view illustrating a state in which the mobile station transmits to the base stations a radio wave representing the transmitting time from the mobile station to the respective base stations and an own IDM of the mobile station, in the transmit and receiving time detecting step for locating the position of the mobile station executed at S6 and S7 in FIG. 11.

FIG. 20 is a view illustrating another example of the position locating space, and another arrangement of the stationary transmitters and the base stations within the position locating space, corresponding to FIG. 1.

### EXPLANATION OF REFERENCES

10: Mobile station position locating system
P: Position locating space
M: Mobile station
K1, K2, K3, K4: Base stations
C1, C2, C3, C4: Stationary transmitters
S3: stationary-transmitter clock tuning step
S4: Base-station position calculating step
S5: Base-station clock tuning step
S8, S9: Mobile-station position calculating step

### DETAILED DESCRIPTION OF THE PREFERRED EMBODIMENTS

Now, a first embodiment according to the present invention will be described below in detail with reference to the accompanying drawings.

### Embodiment

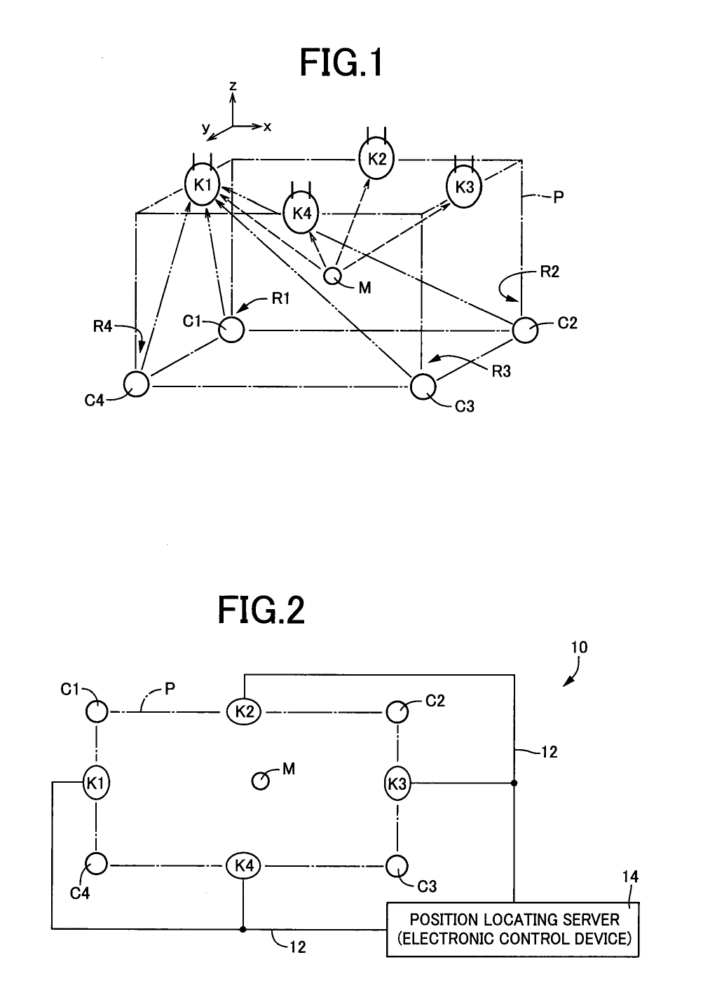

FIGS. 1 and 2 are views showing a structure of a position locating space P and a mobile station position locating system 10 to which the present invention is preferably applied. The mobile station position locating system 10 has plural, i.e., four base stations K1 to K4. The base stations K1 to K4 receive a radio wave transmitted from a mobile station M moveable in a predetermined position locating space P for locating a position (x, y, z) of the mobile station M. The predetermined position locating space P includes a material yard or the like including an indoor place, a warehouse place and an in-and-outside place, with a length of about for instance a few meters to a hundreds and several tens meters. The base stations K1 to K4 are connected to a position locating server 14 via communication lines 12 such as wired or wireless networks and LAN cable networks or the like. The base stations K1 to K4 are set at relatively high places such as those of, for instance, columns, beams, walls and ceilings, etc., with a good view so as to surround the position locating space P for thereby increasing receiving sensitivity.

To facilitate easy understanding, as shown in FIGS. 1 and 2, in the present embodiment, the position locating space P is shown by a rectangular solid in which the base stations K1 to K4 are located at central areas of four sides surrounding an upper surface of the rectangular solid. In addition, since the base stations K1 to K4 are placed in such high places, not only accurately locating the positions of them takes time but also obtaining increased locating precision is difficult. With the above view in mind, stationary transmitters C1 to C4 are disposed at known positions, i.e., four corner portion R1, R2, R3 and R4 of the position locating space P to accurately locating the positions of the base stations K1 to K4, respectively.

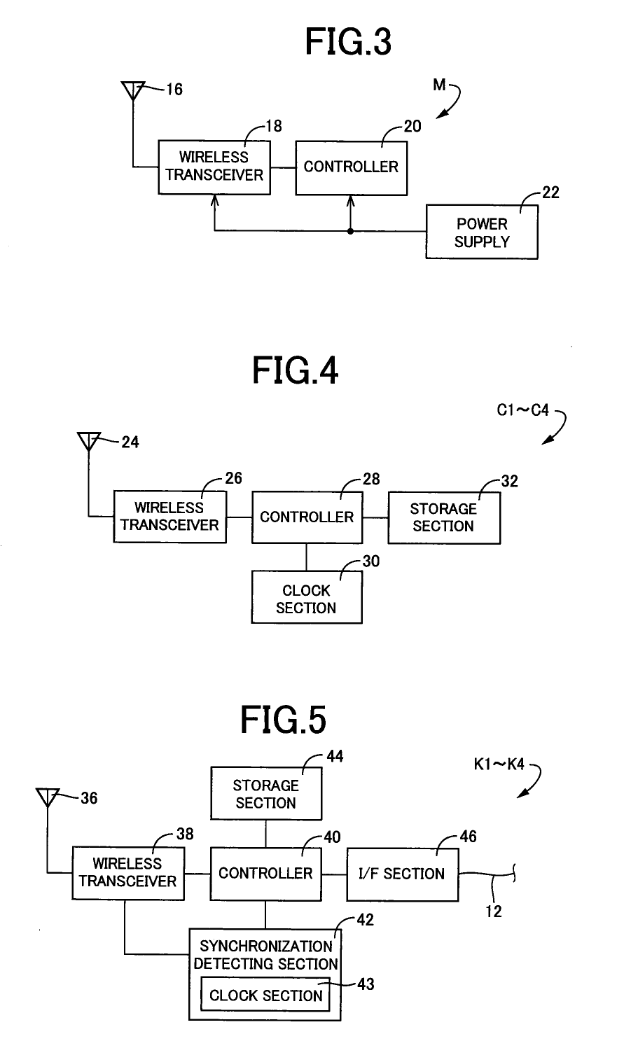

FIGS. 3 to 6 are block diagrams schematically illustrating structures of the mobile station M, the stationary transmitters C1 to C4, the base stations K1 to K4 and the position locating server 14. In FIG. 3, the mobile station 14 includes a wireless transceiver 18 and a controller 20. The wireless transceiver 18 discriminates a radio wave received at an antenna 16 to output a demodulated signal. At the same time, the wireless transceiver 18 demodulates input signals such as spread spectrum synchronizing codes and own identification codes generated by the controller 20 by a carrier frequency of for instance 2.4 GHz band, and transmits radio wave from the antenna 16. The controller 20 serves to interpret receive signals and to control the generation of transmit signals in response to commands interpreted from the receive signals.

The mobile station M is formed in an adhesible tag shape, a card shape and a label shape each with a relatively thin structure available to be attached onto a position locating object such as a live body and an article or the like to be moveable therewith. To supply electric power for the radio wave transmission/receipt and electric power for the control, the mobile station M includes a battery or a power supply 22 connectable to a power supply of the article, so that transmit radio wave with transmission electric power available to reach at least an inside of the position locating space P can be obtained.

In FIG. 4, each of the stationary transmitters C1 to C4 includes a wireless transceiver 26 arranged to discriminate the radio wave received at an antenna 24 to thereby output demodulated signals, and to modulate the input signals to thereby transmit radio wave from the antenna 24. Each of the stationary transmitters C1 to C4 also includes a controller 28 for controlling the receive signals and the transmit signals, a clock section 30 having a reference clock to sequentially output a time information, a storage section 32 for temporarily storing the receive signals while storing control programs and an own ID or the like, and a case 34 accommodating therein the wireless transceiver 26, the controller 28, the clock section 30 and the storage section 32. As shown in FIG. 7 for instance, the case 34 is located in a known area, for instance, a corner portion on a floor of the position locating space P for determining the position of each of the base stations K1 to K4.

As shown in FIG. 7, the case 34 has an upper surface on which the antenna 24 stands upright at a position lying in a certain relationship with the position of a corner point of the position locating space P. If the case 34 is placed in the position locating space P with a back side held in tight contact with orthogonal sidewalls of the corner portion of the position locating space P, the position of the antenna 24 becomes known provided that the position of the corner portion of the position locating space P is known. It is suppose that for instance the antenna 24 is spaced from two orthogonal back sides of the case 34 by distances “e” and “f”, the antenna 24 of the stationary transmitter C1 is spaced from a bottom wall of the case 34 by a distance “h”, and the corner point has a known position expressed as (xC1, yC1, zC1). Under such supposition, a set-up position of the stationary transmitter C1, i.e., the position of the antenna 24 is expressed as (xC1+e, yC1+f, zC1+h). If these distances “e”, “f” and “h” have nonnegligible values in terms of position-locating precision, the corrected position of the antenna 24 is used as the set-up position of the stationary transmitter C1.

Returning to FIG. 5, each of the base stations K1 to K4 includes a wireless transceiver 38, a controller 40 and a synchronization detecting section 42. The wireless transceiver 38 discriminates the radio wave received at an antenna 36 to output demodulated signals, and modulates input signals to transmit from the antenna 36. The controller 40 interprets various information from the receive signals and controls transmit signals in response to commands delivered from an I/F section 46. The synchronization detecting section 42 computes correlation coefficients of the spread spectrum receive signals (synchronizing signals) using a replica, and sequentially outputs time information (signal receiving time) by referring to an output of a clock section 43 having a reference clock. Each of the base stations K1 to K4 further includes a storage section 44 for temporarily storing the receive signals and storing control programs and own IDs IDK1 to IDK4, etc., and the I/F section (an input and output interface section) 46. As shown in FIG. 1, the base stations K1 to K4 are set up to the position locating space P on the upper area thereof, for instance, at the intermediate portions of the four sides surrounding the ceiling, and connected to the position locating server 14 via the I/F sections 46 and the communication lines 12, respectively.

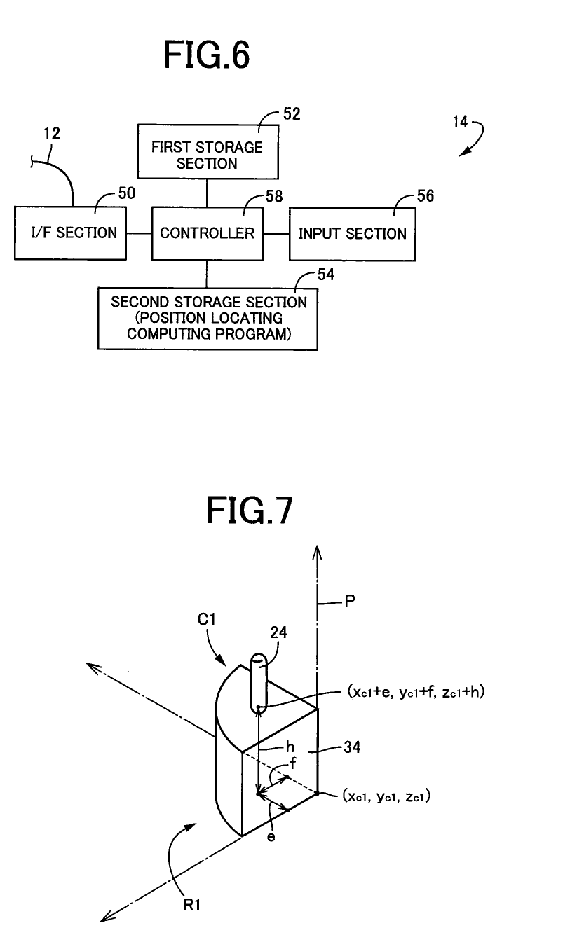

In FIG. 6, the position locating server 14 composed of a so-called computer includes an I/F section (input and output interface section) 50 connected to the base stations K1 to K4 via the communication line 12, a first storage section 52 for temporarily storing the receive signals, a second storage section 54 in which a position locating program is preliminarily stored, and an input section 56 composed of a keyboard or a mouse, etc., for inputting signals. In addition, the position locating server 14 further includes a controller 58 operative to process signals input from the input and output interface section 50 in accordance with preliminarily stored position locating computing programs, and to output commands via the input and output interface section 50 to calculate the positions of the base stations K1 to K4 and the position of the mobile station M. The position of the mobile station M calculated by the controller 58 is displayed on a display device (not shown) and transmitted to other terminal devices (not shown) connected via the communication line 12.

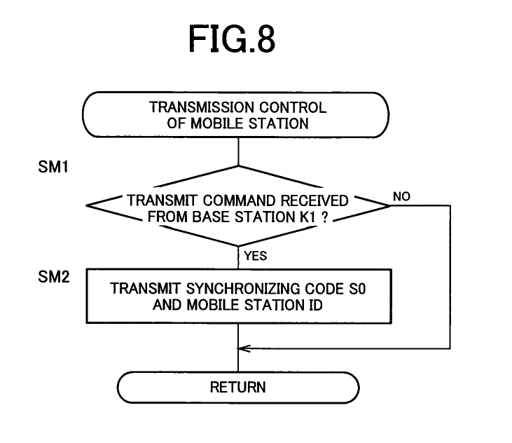

FIG. 8 is a flow chart showing a major part of control operations to be executed by the controller 20 of the mobile station M. At step (hereinafter the term “step” is omitted) SM1 in FIG. 8, a determination is made as to whether the mobile station M receives a command from any base station. As long as the determination of SM1 is no, the execution at SM2 is skipped. If the determination of SM1 is yes, then at SM2, the mobile station M transmits a signal indicative of the own IDM, and a spread spectrum synchronizing code S0 processed in terms of an M sequence sign and Gold sequence sign to allow the base stations K to accurately detect receive timings. Such transmission is repeatedly executed for a relatively short predetermined cycle depending on needs.

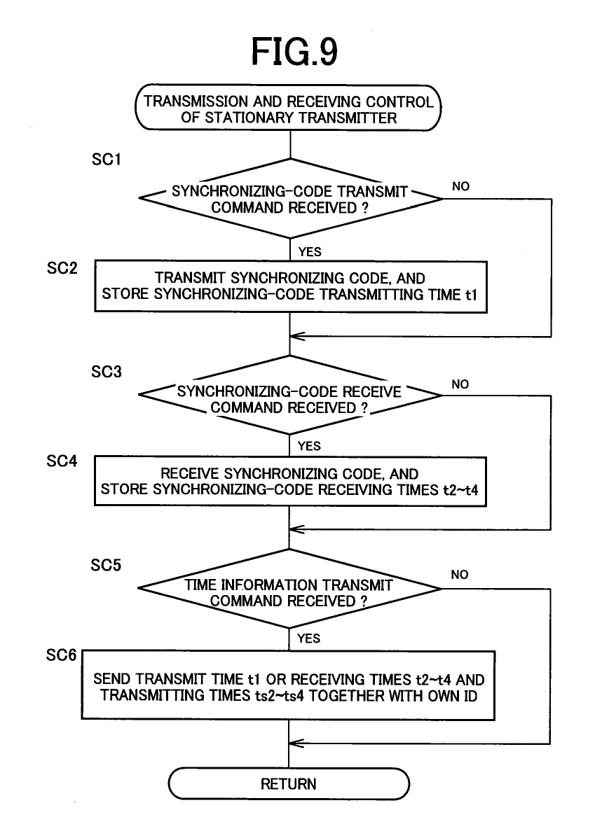

FIG. 9 is a flow chart showing a major part of control operations to be executed by the stationary transmitters C1 to C4. At SC1 in FIG. 9, a determination is made as to whether the stationary transmitters C1 to C4 receive a synchronizing-code transmit command from for instance the base station K1. As long as the determination of this query is no, the execution at SC2 is skipped. If the determination of this query is yes, then at SC2, the own ID stored in the storage section 32, and a radio wave modulated with the spread spectrum synchronizing code are transmitted, with relevant transmitting time t1 being stored in the storage section 32. At succeeding step SC3, a determination is made as to whether the stationary transmitters C1 to C4 receive a receive command of a synchronizing-code from the base station K. As long as the determination of SC3 is no, the execution at SC4 is skipped. If the determination of SC3 is yes, then at SC4, the synchronizing code is received and the receiving times t2 to t4 are stored in the storage sections 32, respectively.

At SC5, a determination is made as to whether the stationary transmitters C1 to C4 receive a time-information transmit command. As long as the determination of SC5 is no, the execution at SC6 is skipped. If the determination of SC5 is yes, then at SC6, transmitting time information t1 or receiving time information t2 to t4 both being preliminarily stored, are transmitted together with the own ID. During transmission, further, the receiving times ts1 to ts4 from the stationary transmitters are also transmitted. For instance, when the base station K1 sends a synchronizing-code transmit command to designate the stationary transmitter C1, and the stationary transmitter C1 receives the synchronizing-code transmit command, the stationary transmitter C1 mainly executes the operations at SC1 and SC2. Upon receipt of the synchronizing-code receive command, the other stationary transmitters C2 to C4 execute the operation at SC3 and SC4. Thereafter, the stationary transmitters C1 to C4 execute the operations at SC5 and SC6 upon receipt of a time-information transmit command transmitted from the base station.

Thus, the base station K1 receives the radio wave, including a signal representing the transmitting time t1 transmitted from the one stationary transmitter C1 and a signal representing receiving times t2 to t4 transmitted from the other stationary transmitters C2 to C4 in such a way noted above, together with signal representing the transmitting times ts1 to ts4 of those signals and IDC1 to IDC4 for identifying the respective stationary transmitters in a manner described below.

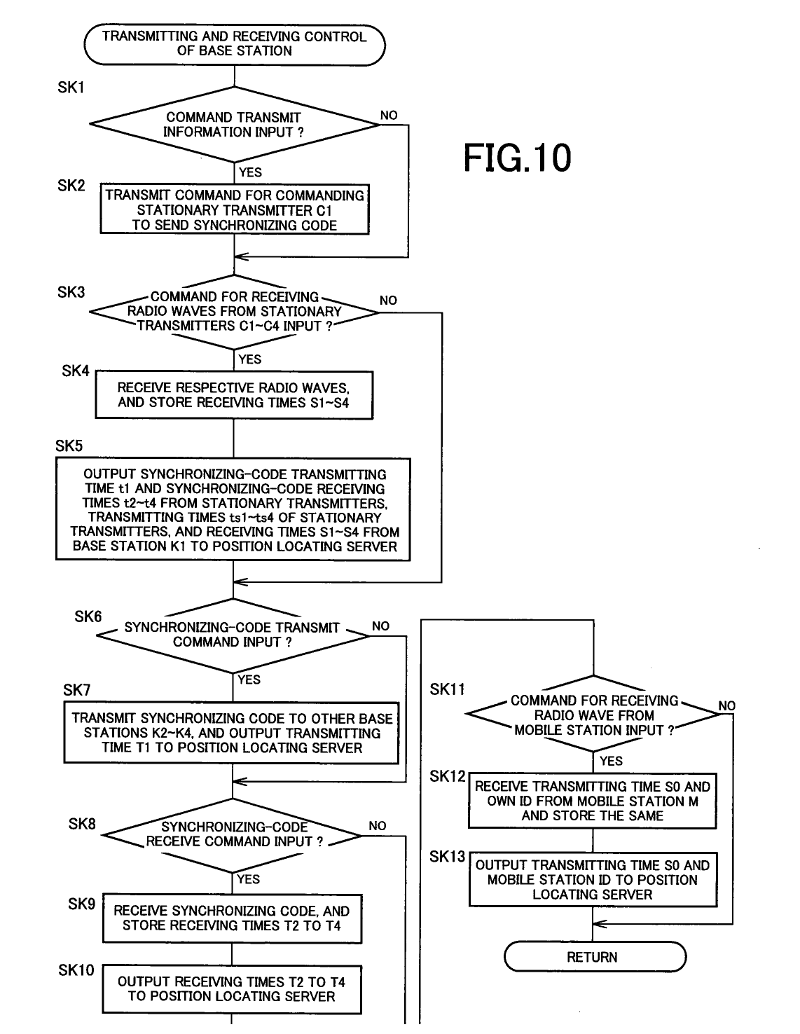

FIG. 10 is a flow chart showing a major part of control operations to be executed with the controller 40 of the base station K1.

In FIG. 10, at SK1, a determination is made as to whether a command is input to the base station K1 from the position locating server 14 for transmitting a command (transmit command) to cause the stationary transmitter C1 to transmit the radio wave indicative of the synchronizing code. As long as the determination of SK1 is no, the execution at SK2 is skipped. If the answer is yes, at SK2, the base station K1 transmits to the stationary transmitter C1 the radio wave representing the command for causing the stationary transmitter C1 to transmit the synchronizing code. Next, at SK3, a determination is made as to whether a command is input to the base station K1 from the position locating server 14 for receiving the radio wave from the stationary transmitter. As long as the determination of SK3 is no, the execution at SK4 is skipped. If the answer is yes, at SK4, the base station K1 receives the radio waves transmitted from the stationary transmitters C2 to C4, and stores the receiving times s1 to s4. At consecutive SK5, the synchronizing code transmitting time t1 of the stationary transmitter C1, the synchronizing code receiving times t2 to t4 of the stationary transmitters C2 to C4, the transmitting times ts1 to ts4 of the radio waves of the stationary transmitters C2 to C4 relative to the base station K1, and the receiving times s1 to s4 of the base station K1 are output to the position locating server 14.

At succeeding SK6, a determination is made as to whether a command is input to the base station K1 from the position locating server 14 to transmit a command (transmit command) for requesting the base station K1 to transmit the radio wave indicative of the synchronizing code. As long as the determination of SK6 is no, the execution at SK7 is skipped. If the answer is yes, at SK7, the base station K1 transmits to the stationary transmitter C1 the radio wave representing the command requesting the stationary transmitter C1 to send or to transmit the synchronizing code.

Next, at SK7, the base station K1 transmits the synchronizing code to the other base stations K2 to K4 with storing the relevant transmitting time T1 in the storage section 44, and the transmitting time T1 and IDK1 of the base station K1 are output to the position locating server 14. At succeeding step SK8, a determination is made as to whether a command is input to the base station K1 from the position locating server 14 for receiving the synchronizing codes from the other base stations K2 to K4. As long as the determination of SK8 is no, the executions of SK9 and SK10 are skipped. If the answer is yes, the other base stations K2 to K4 receive the radio wave transmitted from the base station K1, and the storage section 44 stores the receiving times T2 to T4. At succeeding SK10, the receiving times T2 to T4 and IDM2 to IDM4 of the base stations K2 to K4 are output to the position locating server 14.

At consecutive SK11, a determination is made as to whether a command is input to the base station K1 from the position locating server 14 for receiving the radio wave from the mobile station M. As long as the determination of SK11 is no, the executions at SK12 and SK13 are skipped. If the answer is yes, at SK12, the base station K1 receives radio wave from the mobile station M and the relevant receiving time S1 is stored. At subsequent SK13, the receiving time S1, and the transmitting time S0 from the mobile station M and the base-station IDM are output to the position locating server 14.

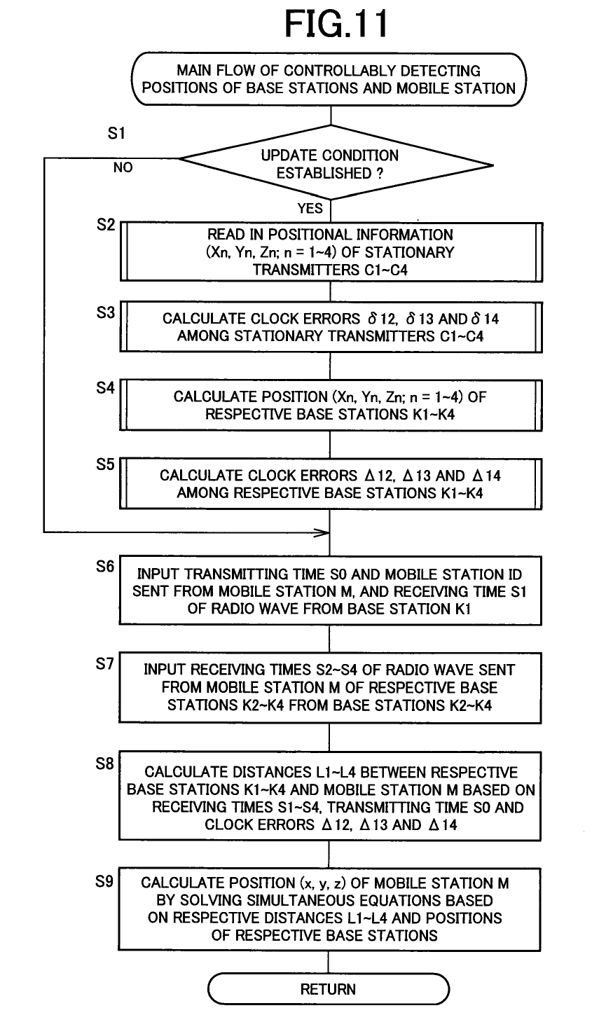

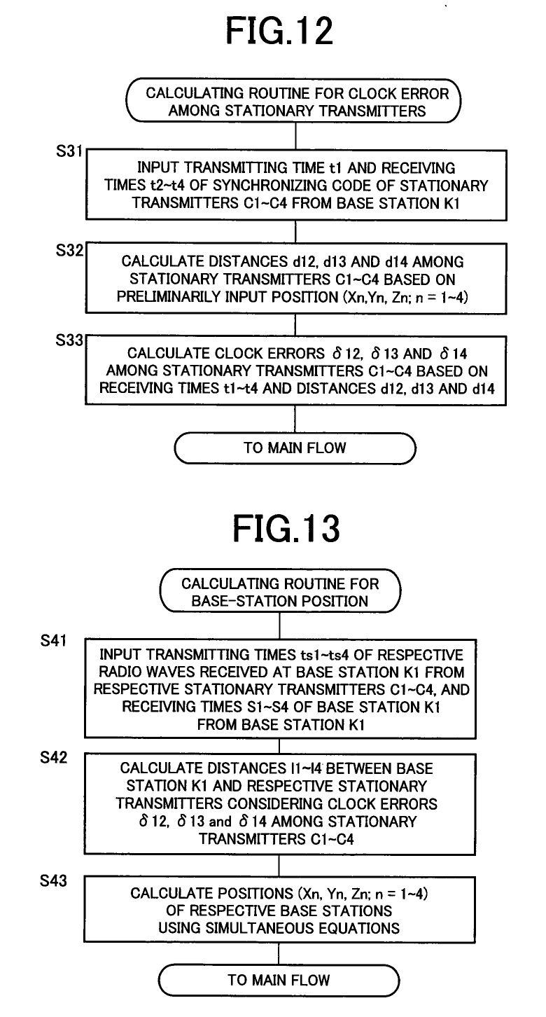

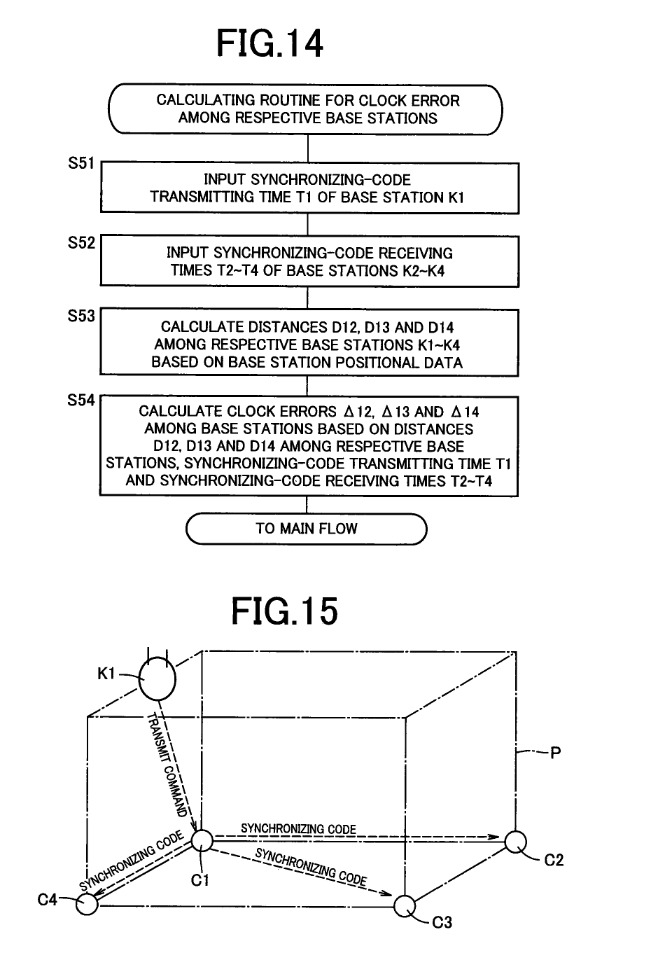

FIGS. 11 to 14 are flow charts for illustrating the control operations to be executed with the position locating server 14, among which FIG. 11 represents a main flow of position locating control, FIG. 12 represents clock gap calculating routine between stationary transmitters shown in FIG. 11, FIG. 13 represents a base-station position calculating routine show in FIG. 11, and FIG. 14 represents a clock gap calculating routine between base stations.

Prior to executing the main flow shown in FIG. 11, work or process is conducted corresponding to a stationary transmitter setting up step. That is, work is conducted to set up the stationary transmitters C1 to C4 at locations, i.e., portions available to easily obtain positional data on intersecting points of boundary lines, e.g., at inside areas of four corners R1 to R4 on a floor in the position locating space P as shown in FIG. 1. At the same time, input operations to the first storage section 52 are conducted by the input section 56, to store set-up positions or locations (xn, yn, zn; n=1˜4) of the stationary transmitters C1 to C4 read out from a drawing of a structural construction forming a shell of the position locating space P. In general, for the structural construction CAD data upon design in the form of electronic data is employed for providing the set-up positions of the stationary transmitters C1 to C4 plotted on the drawing for thereby rendering the set-up positions (xn, yn, zn; n=1˜4) of the stationary transmitters C1 to C4.

Subsequently, the main flow shown in FIG. 1 is executed in response to a position-locating commencing operation executed by an operator with using the input section 56. First at S1 in FIG. 11, the operation is executed based on an input signal applied to the position locating server 14 from the input section 56 and the receive signals or the like to determine as to whether an update condition is established. Examples of the update condition include a new installation of at least a part of the base stations K1 to K4 and changes in set-up positions thereof, and component replacements made for the base stations K1 to K4 and the stationary transmitters C1 to C4, especially repairs and replacements of component parts for the clock section 30, the clock section 43 and the synchronization detecting section 42. If the determination of S1 is no, then steps subsequent to S6 are executed for calculating the position of the mobile station M.

If the determination of S1 is yes, then at S2, set-up position information (xn, yn, zn; n=1˜4) of the stationary transmitters C1 to C4 preliminarily input from the input section 56 and stored in first storage section 52 is read in the position locating server 14 from the first storage section 52. If a deviation exists between set-up position data and an antenna position, then the read-in is conducted for instance after correcting, as shown in FIG. 7 depending on needs.

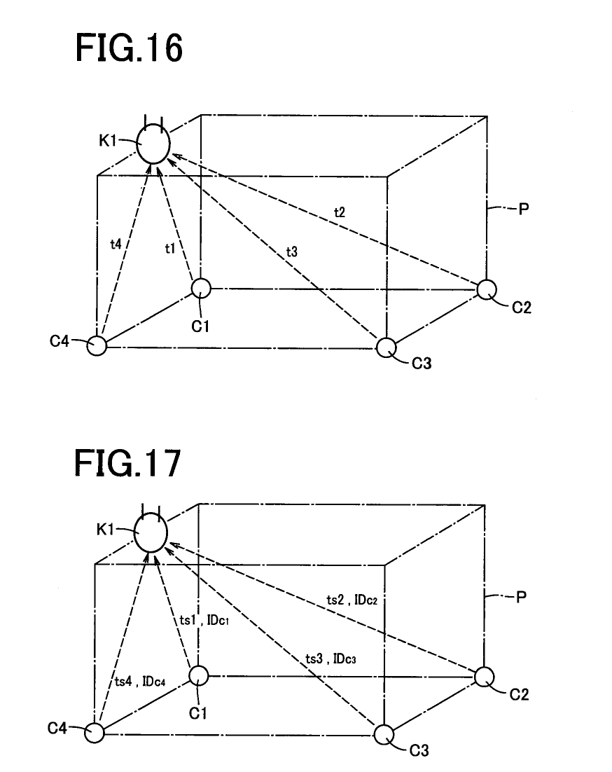

Next, at S3 a stationary-transmitter-to-transmitter clock gap calculating routine corresponding to a stationary-transmitter clock tuning step or stationary-transmitter clock tuning means is executed in a manner as shown in FIG. 12. At S31 in FIG. 12, the base station K1 is compelled to send a transmit command in a manner as shown in FIG. 15 for allowing the respective storage sections 32 to store the transmitting time t1 at which the stationary transmitter C1 transmits the synchronizing code upon receipt of such a transmit command, and the receiving times t2 to t4 at which the other stationary transmitters C2 to C4 receive the synchronizing code. At the same time, as shown in FIG. 16, the transmitting time t1 and the receiving times t2 to t4 are transmitted to the base station K1 to be preliminarily stored in the storage section 44 of the base station K1. At S31 in FIG. 12, the transmitting time t1 and the receiving times t2 to t4 are read into the first storage section 52 from the base station K1. Subsequently, at S32, actual distances d12, d13 and d14 between the stationary transmitter C1 and the other stationary transmitters C2 to C4 are calculated based on the known positions (xn, yn, zn; n=1˜4) of the stationary transmitters C1 to C4 by referring to preliminarily stored equations as expressed below.

d12=√[(x1−x2)²+(y1−y2)²+(z1−z2)²]

d13=√[(x1−x3)²+(y1−y3)²+(z1−z3)²]

d14=√[(x1−x4)²+(y1−y4)²+(z1−z4)²]

At S33, clock gaps 612, 613 and 614 (sec) between the clock section 30 of the stationary transmitter C1 and the clock sections 30 of the other stationary transmitters C2 to C4 are calculated. This calculation is executed based on the actual distances d12, d13 and d14 between the stationary transmitter C1 and the other stationary transmitters C2 to C4, and the transmitting time t1 of the stationary transmitter C1 and the receiving times t2 to t4 of the other stationary transmitters C2 to C4. For instance, the equation representing the clock gap 612 between the clock section 30 of the stationary transmitter C1 and the clock section 30 of the stationary transmitter C2, can be modified to yield δ12=d12/c−(t2−t1). The right side of this equation has a 1st term representing a theoretical propagation time obtained by dividing the distance d12 by a speed “c” of the radio wave. A 2nd term represents an actually measured propagation time indicative of a time between the transmitting time t1 measured by the clock section 30 of the stationary transmitter C1, and the receiving time t2 measured by the clock section 30 of the stationary transmitters C2. If the clock sections 30 operate correctly, the clock gap δ12 becomes zero. If either one of these clock sections 30 has a time deviation, the clock gap δ12 having a positive or negative value is obtained. In addition, in various equations subsequent to the following equations, “c” represents a speed of a radio wave (light speed) that is preliminarily determined and stored.

δ12=(t1+d12/c)−t2

δ13=(t1+d13/c)−t3

δ14=(t1+d14/c)−t4

Turning back to FIG. 11, at S4 a base-station position calculating routine corresponding to a base-station position calculating step or base-station position calculating means is executed as shown in FIG. 13. The stationary transmitters C1 to C4 transmit to the base station K1 the radio waves each including a signal representing the transmit (sending) time t1 at which the synchronizing code is transmitted from the stationary transmitter C1, and a signal representing the receiving times t2 to t4 at which the synchronizing codes are transmitted from the other stationary transmitters C2 to C4. At this time, as shown in FIG. 17, the stationary transmitters C1 to C4 also send transmit (sending) to the base station K1 times ts1 to ts4 representing respective transmitting time information, and respective IDs. Therefore, at S41 in FIG. 13, the transmitting times ts1 to ts4 of the radio waves transmitted to the base station K1 from the stationary transmitters C1 to C4, and the receiving times s1 to s4 of the base station K1 at which those radio waves are received, are input to position locating server 14 from the base station K1.

Subsequently, at S42, propagation distances l1, l2, l3 and 14 of the radio waves passing through four paths between the base station K1 and the stationary transmitters C1 to C4 are calculated. The calculation is based on the transmitting times ts1 to ts4 and the receiving times s1 to s4, in view of the clock gaps δ12, δ13 and δ14 (sec) between each of the stationary transmitters C1 to C4, by referring to preliminarily stored equations described below. In the following equations, the propagation distances l1 to l4 are calculated by multiplying propagation times (s1−ts1), [(s2−(ts2+δ12)], [(s3−(ts3+δ13)] and [(s4−(ts4+δ14)] by the speed “c” of the radio wave, respectively.

l1=c(s1−ts1)

l2=c[s2−(ts2+δ12)]

l3=c[s3−(ts3+δ13)]

l4=c[s4−(ts4+δ14)]

At next S43, the set-up positions (xn, yn, zn; n=1˜4) of the stationary transmitters C1 to C4 are calculated based on the distances l1 to l4 and the set-up positions (xn, yn, zn; n=1˜4) of the stationary transmitters C1 to C4 by referring to simultaneous equations that are preliminarily stored. The following preliminarily stored simultaneous equations are used for calculating a set-up position (X1, Y1, Z1) of the stationary transmitter C1. The same simultaneous equations may be also used for calculating the set-up positions or locations (Xn, Yn, Zn; n=2˜4) of the stationary transmitters C2 to C4.

$$√ [ \begin{matrix}{( X 1 - x 2 )}^{2} + \\ {( Y 1 - y 2 )}^{2} + {( Z 1 - z 2 )}^{2}\end{matrix} ] - √ [ \begin{matrix}{( X 1 - x 1 )}^{2} + \\ {( Y 1 - y 1 )}^{2} + {( Z 1 - z 1 )}^{2}\end{matrix} ] = 12 - 11$$

$$√ [ \begin{matrix}{( X 1 - x 3 )}^{2} + \\ {( Y 1 - y 3 )}^{2} + {( Z 1 - z 3 )}^{2}\end{matrix} ] - √ [ \begin{matrix}{( X 1 - x 1 )}^{2} + \\ {( Y 1 - y 1 )}^{2} + {( Z 1 - z 1 )}^{2}\end{matrix} ] = 13 - 11$$

$$√ [ \begin{matrix}{( X 1 - x 4 )}^{2} + \\ {( Y 1 - y 4 )}^{2} + {( Z 1 - z 4 )}^{2}\end{matrix} ] - √ [ \begin{matrix}{( X 1 - x 1 )}^{2} + \\ {( Y 1 - y 1 )}^{2} + {( Z 1 - z 1 )}^{2}\end{matrix} ] = 14 - 11$$

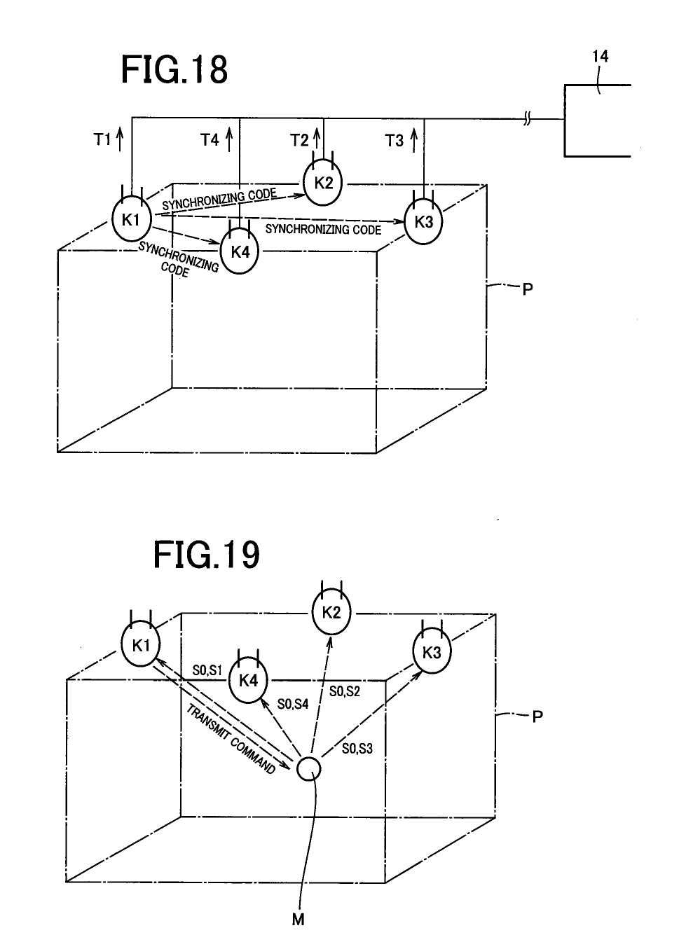

Turning back to FIG. 11, at S5 a base-station-to-base-station clock gap calculating routine corresponding to a base-station clock tuning step or base-station clock tuning means, is executed as shown in FIG. 14. As shown in FIG. 18, at S51 in FIG. 14, as the synchronizing code is transmitted from the base station K1, the base station K1 stores the transmitting time T1 at which the synchronizing code is transmitted in the storage section 44. The stored transmitting time T1 is transmitted to the position locating server 14 to be read into the first storage section 52. Then, as shown in FIG. 18, at S52, the synchronizing code is received at the other base stations K2 to K4 which store the receiving times T2 to T4 of the synchronizing code in the respective storage sections 44. Thus, the receiving times T2 to T4 stored in the base stations K2 to K4 are transmitted to the position locating server 14 for storage in the first storage section 52.

At succeeding S53, the distances D12, D13 and D14 between the base station K1 and the other base stations K2 to K4 are calculated based on the set-up positions (Xn, Yn, Zn; n=1˜4) of the respective base stations calculated at S4, by referring to the following predetermined equations.

D12=√[(X1−X2)²+(Y1−Y2)²+(Z1−Z2)²]

D13=√[(X1−X3)²+(Y1−Y3)²+(Z1−Z3)²]

D14=√[(X1−X4)²+(Y1−Y4)²+(Z1−Z4)²]

Next at S54, clock gaps Δ12, Δ13 and Δ14 (sec) between the clock section 43 of the base station K1 and the clock section 43 of the other base stations K2 to K4 are calculated by referring to predetermined equations described below. The calculation is executed based on the distances D12, D13 and D14 between the base station K1 and the other base stations K2 to K4, the transmitting time T1 transmitted from the base station K1, and the receiving times T2 to T4 of the other base stations K2 to K 4. For instance, the following equation indicating the clock gap Δ12 between the clock section 43 of the base station K1 and the clock section 43 of the base station K2 can be modified as Δ12=D12/c−(T2−T1). A first term of the right side is a theoretical propagation time obtained by dividing the distance D12 by the speed “c” of the radio wave. A second term is an actually measured propagation time which is a time interval between the transmitting time T1 measured at the synchronization detecting section 42 of the base station K1 by referring to the time of the clock section 43, and the receiving time T2 measured at the synchronization detecting section 42 of the base station K2 by referring to the time of the clock section 43. If these clock sections 43 correctly operate, the clock gap Δ12 becomes zeroed. However, if any one of these clock sections 43 is deviated in time, then, the clock gap Δ12 can be obtained in a positive or negative value.

Δ12=(T1+D12/c)−T2

Δ13=(T1+D13/c)−T3

Δ14=(T1+D14/c)−T4

In a manner set forth above, the set-up positions (Xn, Yn, Zn; n=1˜4) of the respective base stations K1 to K4 are calculated, and the clock gaps Δ12, Δ13 and Δ14 (sec) between the clock section 43 of the base station K1 and the clock sections 43 of the other base stations K2 to K4 are calculated. Then, a position locating routine of the mobile station M including the operations at S6 and S7 of FIG. 11 corresponding to transmit-receiving time detecting step or transmit-receiving time detecting means, and S8 and S9 of FIG. 11 corresponding to a mobile-station position calculating step or mobile-station position calculating means are executed.

First at S6 in FIG. 11, a transmit command signal is transmitted from the base station K1 to the mobile station M as shown in FIG. 19. The mobile station M, upon receipt of such a transmit command signal, transmits a radio wave representing to a transmit (send) time S0 and an own IDM of the mobile station M. At succeeding S7, the base stations K1 to K4, upon receipt of such a radio wave, allows the first storage sections 52 to store the receiving times S1 to S4 of the radio waves, the transmitting time S0 indicated by the radio wave, and the own IDM of the mobile station M. At the same time, the transmitting time S0 and the IDM of the mobile station M, and the receiving times S1 to S4 of the base stations K1 to K4 are read into the first storage section 52 from the base stations K1 to K4 through the communication line 12 to the position locating server 14. The transmitting time S0 of the radio wave and the receiving times S1 to S4 represent a propagation time of the radio wave during a time interval from transmission of the radio wave from the mobile station M to receipt thereof by the base stations K1 to K4. Thus, the transmit-receiving time detecting step or the transmit-receiving time detecting means also corresponds to a propagation time detecting step or propagation time detecting means.

Next, at S8 corresponding to base-station-to-mobile-station distance calculating step or base-station-to-mobile-station distance calculating means included in the mobile-station position calculating step, propagation distances L1, L2, L3 and L4 between the base stations K1 to K4 and the mobile station M in propagation of the radio waves passing through the fourth paths are calculated. This calculation is executed based on the transmitting time S0 of the mobile station M and the receiving times S1 to S4 of the base stations K1 to K4 read at S7, and the clock gaps Δ12, Δ13 and Δ14 (sec) between the clock section 43 of the base station K1 and the clock sections 43 of the other base stations K2 to K4, by referring to preliminarily stored equations described below. In the following equations, the propagation distances L1 to L4 are calculated by multiplying actually measured propagation times (S1−S0), (S2+Δ12−S0), (S3+Δ13−S0) and (S4+Δ14−S0) between the transmitting time S0 and the receiving times S1 to S4 in terms of the four paths, by the speed “c” of the radio wave. Accordingly, S8 includes propagation time calculating step or propagation time calculating means.

L1=c(S1−S0)

L2=c(S2+Δ12−S0)

L3=c(S3+Δ13−S0)

L4=c(S4+Δ14−S0)

At S9 corresponding to mobile-station position calculating step, the location (x, y, z) of the mobile station M is calculated based on the set-up positions (Xn, Yn, Zn; n=1˜4) of each of the base stations K1 to K4 calculated at S4, and the distances L1, L2, L3 and L4 between the base stations K1 to K4 and the mobile station M, by referring to the following preliminarily stored equations.

$$√ [ \begin{matrix}{( X 2 - x )}^{2} + \\ {( Y 2 - y )}^{2} + {( Z 2 - z )}^{2}\end{matrix} ] - √ [ \begin{matrix}{( X 1 - x )}^{2} + \\ {( Y 1 - y )}^{2} + {( Z 1 - z )}^{2}\end{matrix} ] = L 2 - L 1$$

$$√ [ \begin{matrix}{( X 3 - x )}^{2} + \\ {( Y 3 - y )}^{2} + {( Z 3 - z )}^{2}\end{matrix} ] - √ [ \begin{matrix}{( X 1 - x )}^{2} + \\ {( Y 1 - y )}^{2} + {( Z 1 - z )}^{2}\end{matrix} ] = L 3 - L 1$$

$$√ [ \begin{matrix}{( X 4 - x )}^{2} + \\ {( Y 4 - y )}^{2} + {( Z 4 - z )}^{2}\end{matrix} ] - √ [ \begin{matrix}{( X 1 - x )}^{2} + \\ {( Y 1 - y )}^{2} + {( Z 1 - z )}^{2}\end{matrix} ] = L 4 - L 1$$

According to the present embodiment, as set forth above, the transmitting times ts1 to ts4 of the radio waves transmitted or sent from the plural stationary transmitters C1 to C4 set up at the known plural positions to the predetermined base station K1, and those receiving times s1 to s4 of the radio waves are detected, respectively. In the base-station position calculating step (at S4), the positions (Xn, Yn, Zn; n=1˜4) of the plural base stations K1 to K4 including the predetermined station K1 are calculated, respectively, based on the transmitting times ts1 to ts4 and the receiving times s1 to s4 of the radio waves, and the known positions (xn, yn, zn; n=1˜4) of the stationary transmitters C1 to C4. Therefore, the positions of these stations K1 to K4 can be accurately located without actually locating the positions thereof. In addition, the position (x, y, z) of the mobile station M can be located based on the distances L1, L2, L3 and L4 of the radio waves transmitted or sent from the mobile station M and received at the plural stations K1 to K4, and the positions (Xn, Yn, Zn; n=1˜4) of the base stations K1 to K4.

Further, the present embodiment includes the stationary-transmitter setting-up step for setting up the plural stationary transmitters C1 to C4 in the position locating space P at the places already positionally located on CAD data. Therefore, the positions of the stationary transmitters C1 to C4 can be accurately and easily obtained and are input to the position locating server (electronic control device) 14 for locating the position of the mobile station.

According to the present embodiment, furthermore, the stationary-transmitter setting-up step sets up the plural stationary transmitters C1 to C4 in the position locating space P at the four places or more for locating the position of the mobile station M. This allows the predetermined stationary transmitter, e.g., the transmitter C1 to send the synchronizing code to the other three stationary transmitters C2 to C4. In this case, the actual distances d12, d13 and d14 between the predetermined stationary transmitter C1 and the other three stationary transmitters C2 to C4 can be obtained by referring to the transmitting time t1 of the predetermined stationary transmitter C1 and the receiving times t2 to t4 of the other three stationary transmitters C2 to C4. The clock gaps δ12, δ13 and δ14 (sec) between the clock section 30 of the stationary transmitter C1 and the clock sections 30 of the other stationary transmitters C2 to C4 or time data generated with reference to the clocks of the clock sections 30 can be obtained.

According to the present embodiment, moreover, the stationary-transmitter setting-up step sets up the plural stationary transmitters C1 to C4 in the position locating space P at the corner portions thereof or at certain places spaced from the corner portions. Thus, accurate locating precision of locating the positions of the stationary transmitters C1 to C4 can be obtained.

The present embodiment includes the stationary-transmitter clock tuning step (S3) in which the mutual clock gaps δ12, δ13 and δ14 between the clock sections 30 incorporated in the plural stationary transmitters C1 to C4 can be obtained based on theoretical propagation times d12/c, d13/c and d14/c of the radio waves and actually measured propagation times (t2−t1), (t3−t1) and (t4−t1). Theoretical propagation times d12/c, d13/c and d14/c of the radio waves are calculated based on the actual distances d12, d13 and d14 between the plural stationary transmitters C1 to C4 in terms of the known positions (xn, yn, zn; n=1˜4) of the plural stationary transmitters C1 to C4, and speed “c” of the radio wave. Actually measured propagation times (t2−t1), (t3−t1) and (t4−t1) are actually measured propagation times of the radio waves transmitted or sent from one stationary transmitter C1 to the other stationary transmitters C2 to C4 of the plural stationary transmitters C1 to C4.

In the base-station position calculating step (S4), the propagation distances l1, l2, l3 and l4 are calculated based on the propagation times (s1−ts1), [(s2−(ts2+δ12)], [(s3−(ts3+δ13)] and [(s4−(ts4+δ14)] of the radio waves transmitted or sent from the plural stationary transmitters C1 to C4 to the plural base stations K1 to K4. Such calculation is executed by considering the clock gaps 612, 613 and 614 between the clock sections 30 incorporated in the stationary transmitters C1 to C4. The positions (Xn, Yn, Zn; n=1˜4) of the plural base stations K1 to K4 are calculated based on the propagation distances l1, l2, l3 and l4 and the known positions (xn, yn, zn; n=1˜4) of the plural stationary transmitters C1 to C4. Therefore, the positions (Xn, Yn, Zn; n=1˜4) of the plural base stations K1 to K4 are calculated based on the propagation times of the radio waves transmitted from the plural stationary transmitters C1 to C4 to the plural base stations K1 to K4. Such calculation is executed by considering the mutual clock gaps between the clock sections 30 incorporated in the stationary transmitters C1 to C4, i.e., the clock gaps δ12, δ13 and δ14. As a result, the position (x, y, z) of the mobile station M can be accurately located based on the distances L1, L2, L3 and L4 of the radio waves transmitted from the mobile station M and received at the plural stations K1 to K4, and the positions (Xn, Yn, Zn; n=1˜4) of the base stations K1 to K4.

The present embodiment further includes the base-station clock tuning step (S5) for calculating or acquiring the mutual clock gaps Δ12, Δ13 and Δ14 between the clock sections 43 incorporated in the base stations K1 to K4, based on the theoretical propagation times D12/c, D13/c and D14/c of the radio waves and the actually measured propagation times (T2−T1), (T3−T1) and (T4−T1). The theoretical propagation times D12/c, D13/c and D14/c of the radio waves are calculated based on the distances D12, D13 and D14 between the positions (Xn, Yn, Zn; n=1˜4) of the plural base stations K1 to K4 calculated or acquired by the base-station position calculating step (S4), and the speed “c” of the radio wave. The actually measured propagation times (T2−T1), (T3−T1) and (T4−T1) of the radio wave represent the actually measured propagation times transmitted from one base station K1 of the base stations K1 to K4 to the other base stations K2 to K4.

The present embodiment further includes the mobile-station position calculating step (S8, S9) for calculating the position (x, y, z) of the mobile station M based on the propagation distances L1, L2, L3 and L4, and the position (Xn, Yn, Zn; n=1˜4) of the base stations K1 to K4. The propagation distances L1, L2, L3 and L4 are calculated based on the propagation times (S1−S0), (S2+Δ12−S0), (S3+Δ13−S0) and (S4+Δ14−S0) of the radio waves transmitted from the mobile station M to the plural base stations K1 to K4 by considering the mutual clock gaps Δ12, Δ13 and Δ14 between the base stations K1 to K4. The positions (Xn, Yn, Zn; n=1˜4) of the base stations K1 to K4 are calculated in the base-station position calculating step. Therefore, the position (x, y, z) of the mobile station M can be accurately calculated based on the clock gaps Δ12, Δ13 and Δ14 between the clock sections 43 incorporated in the base stations K1 to K4 and the propagation times (S1−S0), (S2+Δ12−S0), (S3+Δ13−S0) and (S4+Δ14−S0) of the radio wave transmitted from the mobile station M to the plural base stations K1 to K4.

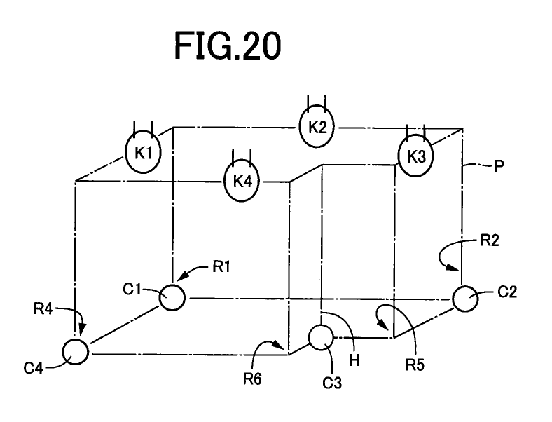

FIG. 20 shows another example of a position locating space P, and another arrangement example for the stationary transmitters C1 to C4 and the base stations K1 to K4 to be positioned within the position locating space P. The position locating space P has one corner, at which the stationary transmitter C3 is disposed in FIG. 1, which is provided with a columnar obstacle D such as a ledge or the like with one edge placed in a protruding position. As a result, the position locating space P is composed of five corners R1, R2, R4, R5 and R6 and one edge H. The stationary transmitter C3 is located at a distal end of one edge as a place with a good view for the base stations K1 to K4, resulting in a reduction in the number of the stationary transmitters as compared to a case wherein the stationary transmitters are located at the five corners R1, R2, R4, R5 and R6, respectively.

While the present invention is described above with reference to the preferred embodiments illustrated in the drawings, the present invention is construed not to be limited to such embodiments described above and may be implemented in other modes.

In the embodiments described above, the mobile station and the base stations K1 to K4 use a carrier frequency of 2.4 GHz band, but another frequency band may be employed. Moreover, a spread spectrum signal is used as the synchronizing code, but a synchronizing code may be transmitted and received over a UWB (Ultra Wide Band) communication.

In the illustrated embodiments, further, the set positions (xn, yn, zn; n=1˜4) of the plural stationary transmitters C1 to C4, the positions (Xn, Yn, Zn; n=1˜4) of the base stations K1 to K4 and the position (x, y, z) of the mobile station M are expressed in terms of the x-y-z orthogonal coordinate system. However, another coordinate system may be employed.

In the illustrated embodiments, furthermore, the simultaneous equations used for calculating the positions (Xn, Yn, Zn; n=1˜4) of the base stations K1 to K4 and the position (x, y, z) of the mobile station M, are simultaneous equations with both sides of the signs being expressed in terms of the distance difference. However, the present embodiments calculate three unknown (Xn, Yn, Zn) or (x, y, z) after the clock gaps are resolved in advance, and, it may suffice to use three simultaneous equations with both sides of a sign indicating a distance per se. In brief, it may suffice to use more than three simultaneous equations capable of acquiring three unknown.

In the illustrated embodiments, moreover, the four stationary transmitters C1 to C4 disposed at the known positions (xn, yn, zn; n=1˜4), and the four base stations K1 to K4 disposed in the set-up positions (Xn, Yn, Zn; n=1˜4), are employed. However, the stationary transmitters and the base stations may include three units, respectively, or five units and more, respectively.

In the illustrated embodiments, at step SM1 in FIG. 8, a query is made as to whether the mobile station M receives the command from any of the base stations. However, a query may be made as to whether there is a transmit (receive) time at a predetermined fixed frequency.

In the illustrated embodiments set forth above, the transmit and receiving time detecting step (S6 and S7), corresponding to the propagation time detecting step, detects the propagation time of the radio wave based on the transmitting time S0 of the radio wave transmitted from the mobile station M and received at the base stations K1 to K4, and the receiving times S1 to S4 received at the base stations K1 to K4. However, the present invention is construed not to be limited to such a mode described above.

For instance, the propagation times of the radio waves transmitted from the base stations K1 to K4, respectively, and received at the mobile station M may be calculated. The calculation may be achieved to obtain the propagation time of the radio wave exchanged between the base station K1 and the mobile station M in the relationship of S21−S11, and the propagation time of the radio wave exchanged between the base station K2 and the mobile station M in the relationship of S22−S12, based on the transmitting times S11 to S14 of the base stations K1 to K4 and the receiving times S21 to S24 of the radio wave received at the mobile station M. In addition, a propagation time of a radio wave ingoing and outgoing between each of the base stations K1 to K4 and the mobile station M can be detected to regard a value of one half of such a propagation time to be the propagation time for such a propagation.

Although no exemplary illustration on every matter will be given, the present invention can be implemented in various modifications without departing from the scope of the present invention.

1. A mobile station position locating method for locating a position of the mobile station based on propagation times of the radio waves, transmitted and received between a mobile station and plural base stations, and positions of the plural base stations, the mobile station position locating method comprising:
base-station position calculating step that calculates the positions of the plural base stations, based on the propagation times of the radio waves transmitted from plural stationary transmitters set up at plural known positions in a position locating space for the mobile station respectively to the plural base stations, and the known positions of the plural stationary transmitters.

2. The mobile station position locating method according to claim 1, further comprising stationary-transmitter setting-up step that sets up the plural stationary transmitters at a place already positionally determined based on electronic data.

3. The mobile station position locating method according to claim 2, wherein the stationary-transmitter setting-up step sets up the plural stationary transmitters at four places or more in the position locating space.

4. The mobile station position locating method according to claim 2, wherein the stationary-transmitter setting-up step set up the plural stationary transmitters at corner portions thereof or at fixed positions spaced from the corner portions in the position locating space.

5. The mobile station position locating method according to claim 1, further comprising:
stationary-transmitter clock tuning step that calculates clock gaps between the plural stationary transmitters based on (i) the propagation times of the radio waves calculated based on distances between the plural stationary transmitters depending on the known positions of the plural stationary transmitters, and speeds of the radio waves, and (ii) actually measured propagation time of the radio waves representing time periods between a transmitting time of a radio wave transmitted from one of the plural stationary transmitters and a receiving time of the radio wave received at the other stationary transmitters; and
the base-station position calculating step that calculates propagation distances based on the propagation times of the radio waves transmitted from the plural stationary transmitters to the plural base stations with considering the clock gaps between the stationary transmitters, and then calculates the positions of the plural base stations based on the propagation distances and the known positions of the stationary transmitters.

6. The mobile station position locating method according to claim 1, further comprising:
base-station clock tuning step that calculates mutual clock gaps between the base stations based on (i) the propagation times of the radio waves calculated based on distances between the plural base stations obtained by the base-station position calculating step, and speeds of the radio waves, and (ii) actually measured propagation times of the radio waves representing time periods between a transmitting time of the radio wave transmitted from one of the plural base stations and a receiving time of the radio wave received at the other base stations; and
mobile-station position calculating step that calculates the position of the mobile station based on the propagation distances calculated based on the propagation time of the radio wave transmitted from the mobile station to the plural base stations with considering the mutual clock gaps between the base stations, and positions of the base stations calculated by the base-station position calculating step.
